(19) United States
(12) Patent Application Publication
(10) Pub. No.: US 2010/0187409 A1
(43) Pub. Date: Jul. 29, 2010

(54) Method and optical device for manipulating a particle

(76) Inventors: llaria Cristiani, Pavia (IT); Carlo Liberale, Casteggio (IT); Paolo Minzioni, Pavia (IT)

Correspondence Address: Carmen Patti Law Group , LLC, ONE N. LASALLE STREET, 44TH FLOOR, CHICAGO, IL, 60602, US

(21) Appl. No.: 12/449,267

(22) PCT Filed: Jan. 28, 2008
(86) PCT No.: PCT/EP2008/050957

§ 371 Date: Mar. 29, 2010

(30) Foreign Application Priority Data
Jan. 31, 2007 (IT) M12007A 000150

(51) Int. Cl. G21K 1/00

(52) U.S. Cl. 250/251

(57) ABSTRACT

Is disclosed a device for manipulating a particle immersed in a fluid, comprising a probe having a first end, a second end and a longitudinal axis. The probe receives a radiation from a light source and emits the radiation by means of the second end. The probe comprises: an optical guide structure suitable for receiving the radiation. The optical guide structure is configured so that: at the second end, the radiation has an optical intensity distribution with an intensity maximum placed at a non-zero distance from the longitudinal axis of the probe; and in the region of the intensity maximum, the radiation is reflected at the interface between the second end and the fluid and is emitted by the second end so that it converges in a convergence point, thus creating an equilibrium point. The probe further comprises perturbation optical means for perturbing the equilibrium point.

The present invention relates an optical device and method for manipulating a particle, in particular a microscopic particle.

In the following description and in the claims, the term “microscopic particle” (or simply “particle”) will designate a material portion, such as for instance an atom or an ensemble of aggregated atoms, a molecule or an ensemble of aggregated molecules, a cell or an ensemble of aggregated cells, or a cell organelle (such as for instance a mitochondrion), having a maximum size lower than 200 μm.

In the art, optical devices are known allowing to manipulate a microscopic particle which is in suspension within a fluid (such as for instance air, water, physiological solution or the like), i.e. to block it in a desired position or to move it (e.g. by shifting it).

The known optical devices for manipulating a particle are based on a known physical effect which is termed “radiation pressure”. In particular, as explained by A. Ashkin in the paper titled “Optical trapping and manipulation of neutral particles using lasers”, Proc. Natl. Acad. Sci. USA, vol. 94, pages 4853-4860, May 1997, a radiation incident onto a particle gives raise to the radiation pressure applying to the particle two types of forces: the scattering force and the gradient force. The scattering force is directed substantially along the radiation propagation direction, and therefore it pushes the particle towards the radiation propagation direction. On the other hand, the gradient force is directed so as to push the particle towards zones with higher radiation intensity. For instance, if the radiation is a gaussian beam with plane wavefront, the gradient force is directed perpendicular to the beam propagation direction, and it pushes the particle towards the beam centre.

When the radiation is made to converge in a point, the scattering force and the gradient force may create a stable equilibrium point, which is placed close to the convergence point. Therefore, the radiation creates at the stable equilibrium point an “optical trap” towards which the particle is drawn and in which it is trapped.

U.S. Pat. No. 6,416,190 discloses a method and apparatus for controlling an optical trap array. The device comprises a trap optical system wherein a light beam in air impinges on a converging optical element such as a lens objective of a microscope. The lens objective makes the beam converge in a focal point, and the focal point corresponds to the optical trap. If the incident beam is shifted relative to the optical axis, the optical trap may be shifted by a length depending of the lens objective magnification. For providing a three-dimensional trapping, i.e. for counteracting the scattering force, the beam must have a suitable shape at the output of the lens objective.

The inventors have noticed that the optical device for manipulating particles described by U.S. Pat. No. 6,416,190 has some drawbacks.

First of all, since the particle is observed through the same lens objective used for focusing the radiation, which lens objective has a high numerical aperture, the vision field is very narrow, and the focal point is very close to the lens objective. Accordingly, the solution of U.S. Pat. No. 6,416,190 allows to manipulate only particles which are located close to the surface of the fluid nearer to the microscope objective.

Further, the device of U.S. Pat. No. 6,416,190 is very complex and costly to manufacture, and it is very bulky.

In view of the prior art, the inventors have tackled the problem of providing a device and method for manipulating a particle which allows to manipulate a particle independently of the distance of the particle from the free surface of the fluid in which the particle is in suspension.

According to a first aspect, it is provided an optical device for manipulating a particle immersed in a fluid, comprising a light source and a probe having a first end, a second end and a longitudinal axis. The probe is suitable for receiving a radiation from the light source at the first end and to emit the radiation through the second end. The probe comprises:

an optical guide structure suitable for receiving the radiation, the optical guide structure being configured so that:
at the second end, the radiation has an optical intensity distribution with an intensity maximum located at a non-zero distance from the longitudinal axis of the probe; and
in the region of the intensity maximum, the radiation is reflected at the interface between the second end and the fluid and is emitted by the second end so that it converges in a convergence point, thus creating an equilibrium point; and

optical means suitable for perturbing the equilibrium point.

Preferably, at least in the region of the intensity maximum, the probe has a tapered shape having a rotational symmetry about the longitudinal axis and having a given tapering angle. Preferably, the second end of the probe is configured such that it has a non-tapered region which does not overlap with the region of the intensity maximum, the radiation being emitted at least at one point which is positioned in the non-tapered region.

According to a second aspect, the present invention provides a probe having a first end, a second end and a longitudinal axis. The probe is suitable for receiving a radiation from a light source at the first end and for emitting the radiation through the second end. The probe comprises:

an optical guide structure suitable for receiving the radiation, the optical guide structure being configured so that:
at the second end, the radiation has an optical intensity distribution with an intensity maximum placed at a non-zero distance from the longitudinal axis of the probe; and
in the region of the intensity maximum, the radiation is reflected at the interface between the second end and the fluid and is emitted by the second end so that it converges in a convergence point, thus creating an equilibrium point; and

perturbation optical means suitable for perturbing the equilibrium point.

According to a third aspect, the present invention provides a method for manipulating a particle immersed in a fluid, comprising the steps of:

generating a radiation by means of a laser source;

guiding the radiation from a first end to a second end of a probe by means of an optical guide structure so that, at the second end of the probe, the radiation has an optical intensity distribution with an intensity maximum placed at a non-zero distance from a longitudinal axis of the probe;

at the second end and in the region of the intensity maximum, reflecting the radiation at the interface between the second end and the fluid;

emitting the radiation from the second end so that it converges in a convergence point, thus creating an equilibrium point; and

perturbing the equilibrium point.

The present invention will become clearer by the following detailed description, given by way of example and not of limitation, to be read by referring to the accompanying drawings, wherein:

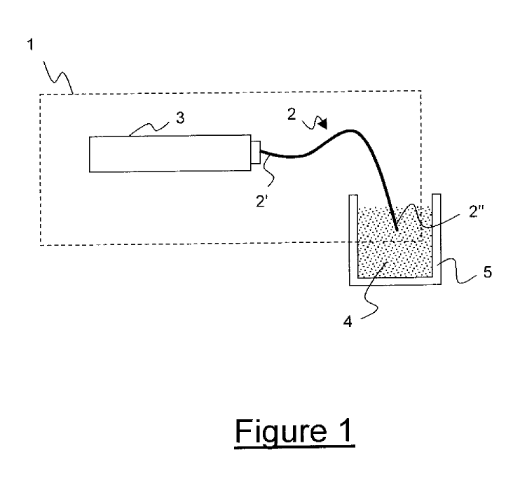

FIG. 1 schematically shows an optical device for manipulating a particle, comprising a probe;

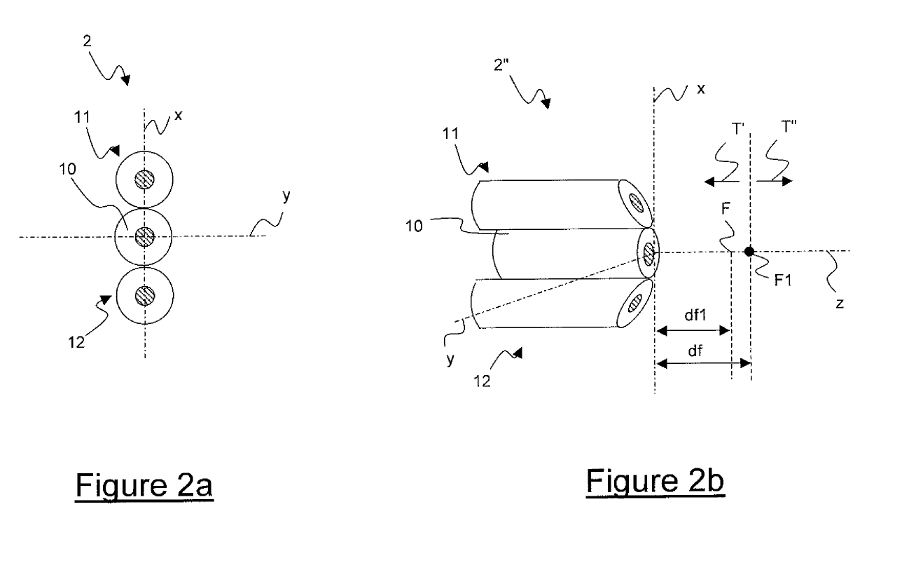

FIGS. 2a and 2b show a cross section and a perspective view, respectively, of a probe of the optical device according to a first embodiment of the present invention;

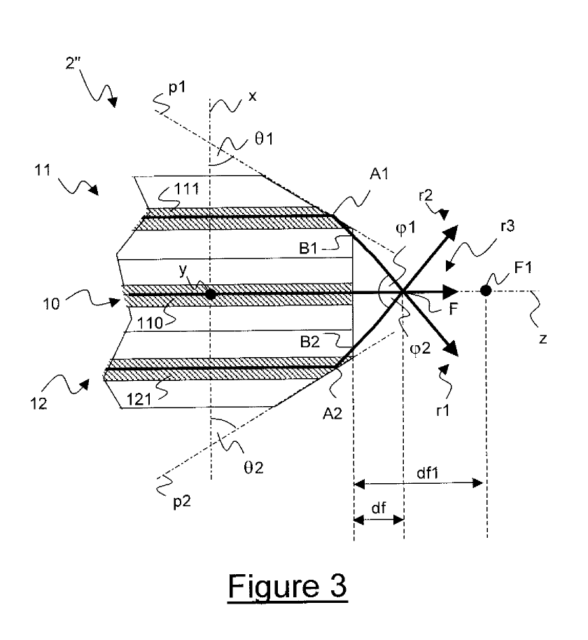

FIG. 3 show a longitudinal section view of the probe of FIGS. 2a and 2b;

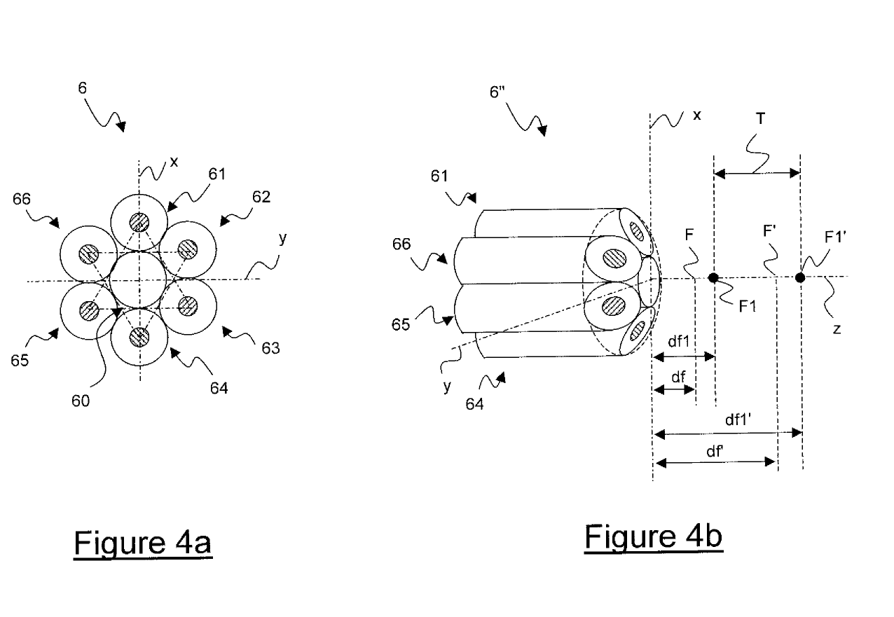

FIGS. 4a and 4b show a cross section and a perspective view, respectively, of a probe of the optical device according to a second embodiment of the present invention; and

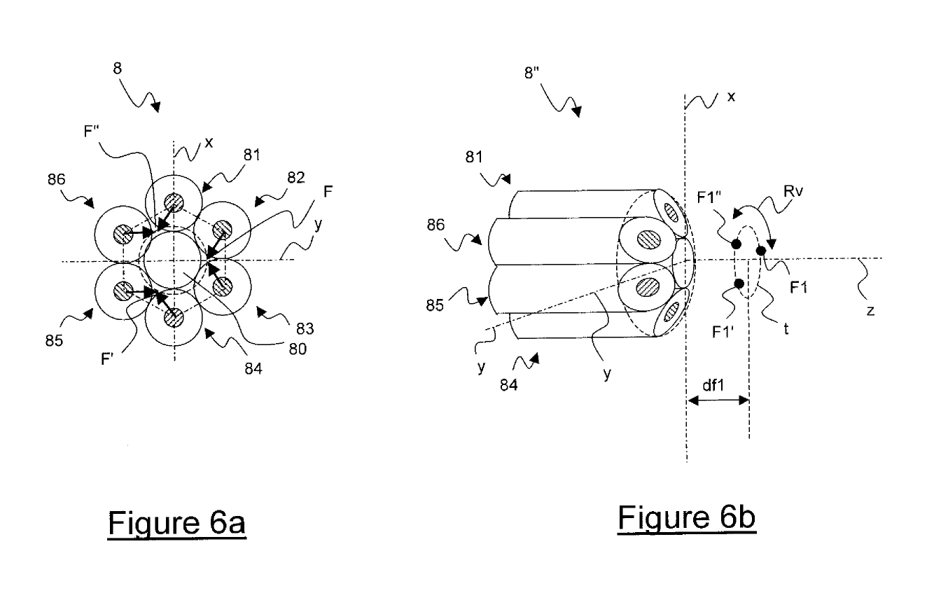

FIGS. 6a and 6b show a cross section and a perspective view, respectively, of a probe of the optical device according to a third embodiment of the present invention.

All the Figures are schematic representations and they are not in scale.

The optical device 1 for manipulating a particle according to the present invention comprises a laser source 3 suitable for emitting a light radiation at a predetermined wavelength. Preferably, the predetermined wavelength is comprised between 500 nm and 2000 nm. The laser source 3 may be a laser source emitting at a constant optical power, or a pulsed laser source. Further, the laser source 3, according to embodiments not shown in the drawings, may comprise a plurality of lasers emitting substantially at a same optical power, as it will be described in detail herein after.

The device further comprises a probe 2, in turn comprising at least one optical fiber (not shown in FIG. 1), as it will be explained in further detail herein after. A first end 2′ of the probe is coupled to the laser source 3, so that the optical fiber(s) guide the light radiation emitted by the laser source 3 from the first end 2′ to a second end 2″ of the probe 2. Such a second end 2″ is suitable for being immersed in a suspension 4 contained in a container 5. The suspension 4 comprises a fluid and the particle in suspension to be manipulated.

FIGS. 2a and 2b show a probe 2 which can be used to implement the device 1 of FIG. 1 according to a first embodiment of the present invention. In particular, the probe shown in FIGS. 2a and 2b is suitable for moving a particle in suspension in a fluid along a predetermined straight direction.

The probe 2 comprises a first optical fiber 11, a second optical fiber 12 and a third optical fiber 10. Preferably, the fibers 11 and 12 have substantially identical optical and geometrical characteristics (such as, for instance, refractive index profile, core and cladding diameters, attenuation, etc.).

Further, preferably, at least at the second end 2″, the fibers 11 and 12 have axis parallel to a first direction indicated as z in FIG. 2b. Further, preferably, at least at the second end 2″, the axes of the fibers 10, 11 and 12 lie on a same plane identified by the direction z and a second direction x. The second direction x is perpendicular to the direction z and is visible in FIGS. 2a and 2b. Therefore, at least at the end 2″, the optical guiding structure formed by the fibers 11 and 12 has a rotational symmetry about the direction z (the rotation angle is)180°.

In the FIGS. 2a and 2b, also a third direction y is shown, which is perpendicular to the direction z and the direction x.

As shown in FIG. 2b, the end 2″ of the probe 2 has a tapered shape with a rotational symmetry about the direction z, as it will be described in further detail herein after by referring to FIG. 3.

FIG. 3 shows the trace of two planes p1, p2 according to which the end 2″ of the probe 2 is tapered. The planes p1 and p2 are both perpendicular to the plane identified by the directions x and z. Further, the plane p1 cutting the first fiber 11 forms an angle Θ1 with the plane identified by the directions x and y, while the plane p2 cutting the second fiber 12 forms an angle Θ2 with the plane identified by the directions x and y.

According to embodiments of the present invention, the surfaces of the fibers 11 and 12 cut according to the planes p1 and p2 may be metalized, for reasons which will be explained herein after.

FIG. 3 shows that the plane p1 preferably cuts the whole core region of the fiber 11, whereas the cladding region of the fiber 11 is only partially cut. More preferably, the plane p1 is positioned so that at least a portion of the cladding region comprised between the fiber core 111 and the fiber 10 is left uncut. The above considerations also apply to the plane p2. This advantageously allows to reduce the time and cost for manufacturing the probe.

In the following description and in the claims, the angles formed by the planes according to which the end of the probe is tapered and by the plane identified by the directions x and y (such as for instance the angles Θ1, Θ2) will be termed “tapering angles”.

Preferably, for preserving rotational symmetry of the optical guide structure formed by the fibers 11 and 12 about the direction z, the tapering angles Θ1 and Θ2 substantially have a same value. Further, preferably, the value of the tapering angles Θ1 and Θ2 is chosen according to criteria which will be explained in further detail herein after.

By referring always to FIG. 3, the operation of the probe 2 will be now explained in detail.

When the laser source (not shown in FIG. 3) emits a light radiation, the light radiation is coupled to the first end of the probe 2, so that a first radiation component is guided by the first fiber 11, and a second radiation component is guided by the second fiber 12. Preferably, the first and second radiation components have substantially the same optical power. In this way, the intensity profile of the radiation guided in the optical guide structure formed by the fibers 11 and 12 also has a rotational symmetry about the axis z.

It is assumed that, at least at the end 2″ of the probe 2, the radiation propagates in the fibers 11 and 12 only according to the respective fundamental modes. Since, as it is known, each of these fundamental modes has a gaussian intensity distribution, wherein the gaussian maximum substantially corresponds to the axis of the respective optical fiber 11, 12, the greatest part of the optical power associated to the first and second radiation component is concentrated in the respective core 111, 121.

FIG. 3 shows, by means of two arrows r1 and r2, the optical paths followed by the first and second radiation components, respectively.

In particular, in a first length the first radiation component travels in the core 111 of the first fiber 11 until a point A1, wherein the fiber 11 is obliquely cut according to the plane p1. In particular, at the point A1, the first radiation component is at least partially reflected. The tapering angle Θ1 is preferably chosen so that the reflected portion of the first radiation component impinges on the interface between the probe and the fluid at a point B1 which is preferably placed on the uncut portion of the cladding region of the fiber 11, as shown in FIG. 3. Accordingly, in the embodiment shown in FIG. 3, the tapering angle Θ1 is higher than 45°. In particular, if the chosen tapering angle Θ1 is higher than 45° and lower than the critical angle of the interface between the fiber 11 and the fluid (not shown in FIG. 3) wherein the particle to be manipulated is immersed, at point A1 the first radiation component undergoes both reflection and refraction (for simplicity, refraction is not shown). Otherwise, if the chosen tapering angle Θ1 is higher than or equal to the critical angle of the interface between the fiber 11 and the fluid (not shown in FIG. 3) wherein the particle to be trapped is immersed, at point A1 the first radiation component impinges on the plane p1 with an angle higher than the critical angle, and therefore it undergoes total reflection. In the embodiments wherein the surfaces of the fibers 11 and 12 cut according to the planes p1 and p2 are metalized, the first radiation component undergoes total reflection at the point A1 for any value of the tapering angle Θ1. Also in this latter case, the tapering angle is anyway chosen higher than 45°, so that the reflected portion of the first radiation component does not intersect the axis z before exiting the probe 2.

Then, the first radiation component propagates until point B1 which, as mentioned above, is place on the interface between the uncut portion of the cladding region of the first optical fiber 11 and the fluid (not shown in FIG. 3) wherein the particle to be manipulated is immersed. At point B1, the first radiation component undergoes refraction, and therefore it is output by the probe with a convergence angle (p1 relative to the direction z. The convergence angle (p1 depends on the tapering angle Θ1 according to the following equation:

$$ϕ 1 = arcsin [ \frac{nF}{nM} sin ( 180 - 2 θ 1 ) ] , \qquad [ 1 ]$$

wherein nF is the average refractive index of the fiber 11 and nM is the refractive index of the fluid wherein the particle to be manipulated is immersed. The angles are expressed in degrees.

Regarding the second radiation component guided by the second fiber 12, since both the structure of the optical guide structure formed by the fibers 11 and 12, and the intensity profile of the guided radiation have rotational symmetry about the direction z, the same considerations relating to the first radiation component apply. Such considerations will be briefly summarized herein after.

In a first length, the second radiation component travels in the core 121 of the second fiber 12 until point A2 wherein the fiber 12 is obliquely cut according to the plane p2. At point A2, the second radiation component is at least partially reflected.

Then, the second radiation component propagates until point B2 of interface between the uncut portion of the cladding region of the second optical fiber 12 and the fluid (not shown) wherein the particle to be manipulated is immersed. At point B2, the second radiation component undergoes refraction, and therefore it is output by the probe with a convergence angle φ2 relative to the direction z. The convergence angle φ2 depends on the angle Θ2 according to above equation [1], wherein the index “1” is replaced by the index “2”.

Therefore, the two convergence angles φ1 and φ2 of the two radiation components are substantially identical. This means that the two radiation components are made to converge at a point F, which is placed on the axis z at a convergence distance df from the end 2″ of the probe 2. In other words, the probe 2 acts as a optical element with converging power, configured to make the radiation emitted by the laser source converge in the point F. Accordingly, when the end 2″ of the probe 2 is immersed in a fluid close to the particle, the radiation output by the probe 2 draws the particle towards the stable equilibrium point F1, placed on the axis z at a distance df1 from the probe end, and it substantially traps the particle in the stable equilibrium point F1.

If a further radiation (always emitted by the source 3 or by another source not shown) is coupled in the optical fiber 10, it is guided by the core 110 and is output by the probe 2 along the direction z of the probe 2, as indicated by the arrow r3. Accordingly, this further radiation applies a scattering force directed along its own propagation direction, i.e. the direction z. Such a scattering force perturbs the equilibrium of the point F1, which then tends to move away from the end 2″ of the probe. Accordingly, a particle trapped in the equilibrium point F1 is moved along the direction z. By controlling the power of the further radiation emitted by the optical fiber 10, the trapped particle may be then manipulated by moving it in a controlled way along the direction z, as shown by the arrows T′ and T″ in FIG. 2b.

The optical device for manipulating particles according to embodiments of the present invention, comprising the probe 2, has several advantages over the above described known probes.

First of all, the converging effect of the probe 2 is obtained not through refraction as in the known devices, but through the combination of two factors:

the radiation in the guide structure has intensity profile with rotational symmetry about the axis z of the probe, wherein the intensity maxima have non-zero distance from the axis z; and

convergence of the radiation guided in the guide structure is implemented through (either partial or total) reflection at the interface between the fibers comprised in the guide structure and the fluid wherein the particle is immersed.

This advantageously allows to obtain convergence angles higher (and therefore more efficient traps) than the angles obtained with known probes, while having at the same time convergence distances higher than distances obtained with known probes. For instance, when nF=1.45 and nM=1.33, the probe according to the first embodiment of the present invention allows to obtain stable optical traps placed at a convergence distance of 10 μm to 200 μm, while the known probes based on a single fiber allow to obtain convergence distances of few microns.

Further, advantageously, the numerical aperture of the probe may be further increased by metalizing the inclined surface of the interface between the probe fibers and the fluid. This advantageously allows to further reduce the angles Θ1 and Θ2, thereby having convergence angles more close to 90°, with an increase of the optical trap stability.

Further, the probe according to the first embodiment of the present invention may be partially immersed in the fluid comprising the particle to be trapped. This advantageously allows to manipulate particles independently of the particle distance from the free surface of the fluid, even in case of controlled atmosphere environments, such as for instance vacuum environments.

Further, advantageously, the probe 2 according to the first embodiment of the present invention allows to separate the particle trapping from the particle moving. Indeed, in the probe of the present device the guide structure with rotational symmetry creates an equilibrium point almost only based on the gradient force, since the convergence effect is present at the zones wherein the greatest part of the optical power is concentrated, thus minimizing the effect of the scattering force. On the other hand, the particle moving in the probe 2 is almost exclusively due to the radiation emitted by the central fiber 10. The movement of the particle may then be independently controlled by controlling the power emitted by the central fiber 10, without affecting the trap stability. Particularly advantageously, such a movement may be obtained without physically moving the probe within the fluid.

The guide structure of the probe 2 comprises only two fibers. However, the guide structure of the probe may comprise any number of fibers, provided that they are arranged according to a rotational symmetry about the probe axis.

Further, the guide structure may comprise different fibers arranged according to a rotational symmetry, or a single fiber having different cores arranged according to a rotational symmetry. Alternatively, the guiding structure may comprise a fiber having a single core for instance having an annular shape about the longitudinal axis of the probe.

According to other embodiments not shown in the drawings, the equilibrium point created by the radiation output by the guide structure with rotational symmetry may be perturbed by changing the features of the radiation itself. For instance, by changing the radiation wavelength, the equilibrium point may be shifted along the longitudinal direction z. Alternatively, by changing the radiation power, the trap force may be changed, thus applying a compression onto the particle.

FIGS. 4a and 4b show a probe 6 suitable for being used for implementing the device 1 of FIG. 1 according to a second embodiment of the present invention. Also the probe 6 is suitable for shifting the particle along a predefined trajectory, as it will be described herein after.

More particularly, the probe 6 of FIGS. 4a and 4b comprises six optical fibers 61, 62, 63, 64, 65, 66 and an elongated central element 60. The central element 60 may be for instance a dielectric material reinforcing element or an optical fiber. Preferably, the optical fibers 61, 63 and 65 have substantially identical optical and geometrical characteristics. Further, preferably, the optical fibers 62, 64 and 66 have substantially identical optical and geometrical characteristics.

Further, preferably, at least at the second end 6″, the central element 60 and the fibers 62, 63, 64, 65, 66 have their axes parallel to the first direction z. Further, preferably, at least at the second end 6″, the axes of the fibers 61, 63 and 65 are places at the vertexes of a first equilateral triangle lying of a plane perpendicular to the direction z, which is shown by a dashed line in FIG. 4a. Similarly at least at the second end 6″, the axes of the fibers 62, 64 and 66 are placed at the vertexes of a second equilateral triangle which lies on a plane perpendicular to the direction z and which is rotated by 180° relative to the first equilateral triangle, which is also shown by a dashed line in FIG. 4a.

Accordingly, at least at the second end 6″, the optical fibers 61, 62 and 63 form a first guide structure having rotational symmetry about the direction z (the rotation angle is)120° and the optical fibers 62, 64 and 66 form a second guide structure also having rotational symmetry about the direction z (the rotation angle is)120°. The first and second guide structures are rotated the one relative to the other by 180°.

As shown in FIG. 4b, the end 6″ of the probe 6 has a tapered shape in the direction z. In particular, the fibers 61, 63 and 65 are obliquely cut according to planes forming, with the plane defined by the directions x and y, respective tapering angles which preferably have a same value, which is termed herein after Θ. Similarly, the fibers 62, 64 and 66 are obliquely cut according to planes forming, with the plane defined by the directions x and y, respective tapering angles which preferably have a same value, which is termed herein after Θ′.

Even though for simplicity FIG. 4b shows that the fibers are cut across their whole section, each fiber is preferably cut in its whole core region, whereas its cladding region is only partially cut. More preferably, at least a portion of the cladding region comprised between the fiber core and the central element 60 is left uncut.

The operation of the probe 6 will be now described in detail.

When the laser source emits a light radiation, such radiation is coupled to the first end of the probe 6, so that each optical fiber 61, 62, 63, 64, 65 and 66 guides a respective radiation component. Preferably, the radiation components guided by the fibers 61, 63 and 65 have substantially the same optical power. In this way, the intensity profile of the radiation guided in the first optical guide structure also has a rotational symmetry about the axis z. Similarly, the radiation components guided by the fibers 62, 64 and 66 preferably have substantially the same optical power. In this way, the intensity profile of the radiation guided in the second optical guide structure also has a rotational symmetry about the axis z.

Also in this case, it is assumed that, at least at the second end 6″ of the probe 6, in the fibers 61, 62, 63, 64, 65 and 66 the radiation propagates only according to the respective fundamental modes, so that the greatest part of the optical power associated to each radiation component is concentrated in the respective core.

When each radiation component reaches the point at which the corresponding fiber is obliquely cut, it undergoes reflection.

Subsequently, the reflected portion of each radiation component propagates within the probe until, at the interface between the respective fiber and the fluid, it undergoes refraction, and then is emitted by the probe. In particular, the fibers 61, 63 and 65 emit the respective components with a convergence angle which has a same value φ, depending on the tapering angle Θ according to the above equation [1]. Similarly, the fibers 62, 64 and 66 output the respective components with a convergence angle which has a same value φ′, depending on the tapering angle Θ′ according to the above equation [1].

This means that the radiation components guided by the fibers 61, 63 and 65 converge at a point F, which is substantially placed on the axis z at a convergence distance df from the end 6″ of the probe 6. Similarly, the radiation components guided by the fibers 62, 64 and 66 converge at a point F′, which is substantially placed on the axis z at a convergence distance df from the end 6″ of the probe 6.

According to embodiments of the present invention, the features of the first optical guide structure and of the second optical guide structure are chosen so that the convergence angle φ is different from the convergence angle φ′. In particular, according to first embodiments, the tapering angle Θ is different from the tapering angle Θ′. According to other embodiments, the average refractive index nF of the fibers 61, 63 and 65 is different from the average refractive index of the fibers 62, 64 and 66. This advantageously allows to create two different equilibrium points F1 and F1 ′, which are placed substantially along the direction z at two different distances df1 and df1′ from the end 6″ of the probe 6.

Accordingly, a particle which is in suspension in a fluid may advantageously be shifted from the equilibrium point F1 to the equilibrium point F1′ and vice versa (as indicated by the arrow T shown in FIG. 4b) by modifying the optical power of the components guided by the first guide structure (fibers 61, 63 and 65) and/or the optical power of the components guided by the second guide structure (fibers 62, 64 and 66).

For instance, at the beginning the optical power of the components guided by the first guide structure may be higher than the optical power of the components guided by the second guide structure, so that the particle is drawn towards the equilibrium point F1 and is trapped in it. Afterwards, the optical power of the components guided by the first guide structure may be reduced or, equivalently, the optical power of the components guided by the second guide structure may be increased, so that the particle is drawn towards the second equilibrium point F1′, thus making a controlled shift from the equilibrium point F1 to the equilibrium point F1′. The particle speed may advantageously be controlled by controlling the change rate of the optical powers of the components guided by the first and second guide structure.

The first and second guide structure in the probe 6 described above comprise fibers arranged along to a same circumference. According to embodiments not shown in the drawings, the first and second guide structure may be concentric. In other words, the first guide structure may comprise a first number of optical fibers (for instance four or six) arranged according to a first circumference, and suitable for converging the respective guided components in a first convergence point F. On the other hand, the second structure may comprise a second number of optical fibers (for instance eight or twelve) which are arranged along a second circumference, concentric relative to the first circumference and having a larger diameter, and which are suitable for converging the respective output component in a second convergence point F′. Therefore, also in this case, a particle which is in suspension in a fluid may advantageously be shifted from the equilibrium point F1 to the equilibrium point F1′ by modifying the optical power of the first guide structure and/or the optical power of the components guided by the second guide structure, similarly to what described above.

According to variants not shown in the drawings, the cut surface of each fiber may be metalized. This advantageously allows to provide a total reflection of each component at the interface between each fiber and the surrounding fluid, independently of the value of the tapering angle.

The above described probe 6 provides that the probe includes only a first and second guide structure, i.e. the translation movement of the particle may take place only between a first and second equilibrium position F1 and F1′.

However, according to variants not shown in the drawings, the probe may comprise any number of optical guide structure having a rotational symmetry about the probe axis, each guide structure being suitable for creating a respective stable equilibrium point.

For instance, a probe comprising six fibers (like the probe 6 shown in FIGS. 4a and 4b) may comprise three different guide structure. By referring to the reference numerals of FIGS. 4a and 4b, the first guide structure may comprise the fibers 61 and 64, the second guide structure may comprise the fibers 62 and 65, whereas the third guide structure may comprise the fibers 63 and 66. Each guide structure would then exhibit a rotational symmetry with a rotation angle of 180°. Further, each guide structure would have a tapering angle of its own, and would therefore deflect the respective components in a different convergence point. This would then create three equilibrium points located on the axis z at three different distances from the probe's end. Therefore, a particle in suspension in a fluid may advantageously be shifted from one equilibrium point to another one, by modifying the optical power of the components guided by the three guide structures, similarly to what described above.

Further, according to embodiments of the present invention, the central element 60 is an optical fiber. Preferably, the optical fiber 60 is coupled to the laser source 3 so that the radiation may be selectively coupled or not coupled to the fiber 60. In this way, advantageously, the radiation emitted by the fiber 60 along the direction z may be used, when needed, to ease shifting of the particle from equilibrium points closer to the probe's end towards equilibrium points farther from the probe's end. Otherwise, if one wishes to bring back the particle to an equilibrium point closer to the probe's end, the radiation emitted by the source 3 may be non coupled to the fiber 60, so that the scattering radiation does not block the particle's movement.

The probe 6 described above and its variants allow not only to manipulate a particle by moving it along the direction z between two or more stable equilibrium points. Advantageously, this probe may also be used for trapping a different particle in each stable equilibrium point, so that interaction between different particles may be investigated.

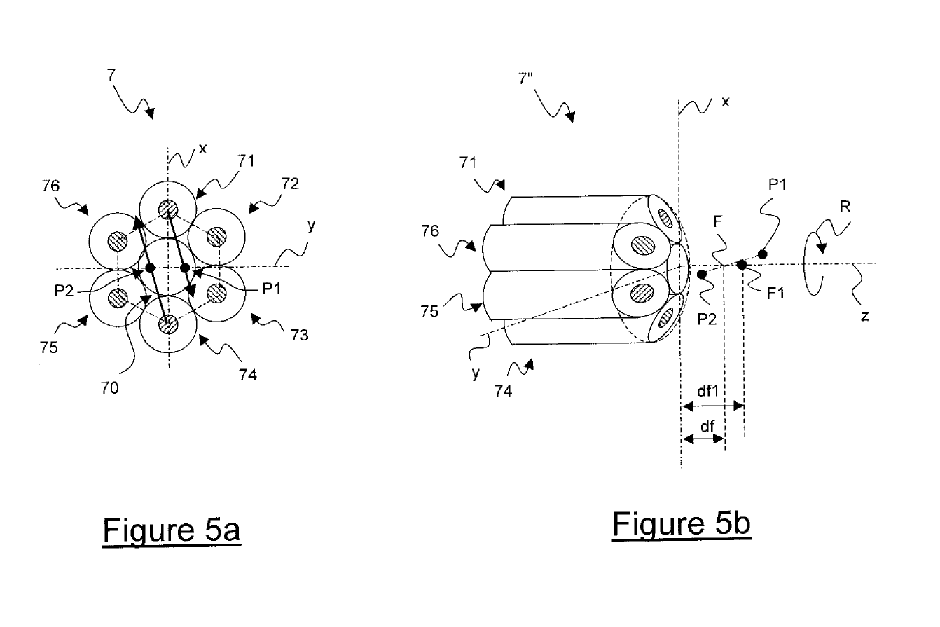

FIGS. 5a and 5b show a probe 7 which can be used for implementing the device 1 of FIG. 1 according to a second embodiment of the present invention. In particular, the probe 7 shown in FIGS. 5a and 5b is suitable for rotating a particle in suspension within a fluid about a predetermined rotation axis.

The probe 7 of FIGS. 5a and 5b comprises six optical fibers 71, 72, 73, 74, 75, 76 and an elongated central element 70. The elongated central element 70 may be for instance a dielectric material reinforcing element, or an optical fiber. Preferably, the optical fibers 71 and 74 have substantially identical optical and geometrical characteristics. Further, preferably, the optical fibers 72, 73, 75 and 76 have substantially identical optical and geometrical characteristics.

Further, preferably, at least at the second end 7″, the central element 70 and the fibers 71, 72, 73, 74, 75, 76 have the axis parallel to the first direction z. Further, preferably, at least at the second end 7″, the axes of the fibers 71 and 74 are located at opposite vertexes of a regular hexagon lying on a plane perpendicular to the direction z, shown by a dashed line in FIG. 5a. Similarly, at least at the second end 7″, the axes of the fibers 72, 73, 75 and 76 are located at the other vertexes of the regular hexagon. Accordingly, at least at the end 7″, the optical fibers 72, 73, 75 and 76 form a guide structure having a rotational symmetry with a rotation angle of 180°.

As shown in FIG. 5b, the end 7″ of the probe 7 has a tapered shape along the direction z.

In particular, the fibers 71, 72, 73, 74, 75 and 76 are obliquely cut according to planes forming with the plane identified by the directions x and y respective tapering angles having a same value, herein after termed Θ. Further, the planes according to which the fibers 71 and 74 are cut form with the plane identified by the longitudinal axis z of the probe 7 and the axis of the fiber 71 and 74 respective deflection angles, which preferably have a same value.

Even though for simplicity FIG. 5b shows that the fibers are cut across their whole section, each fiber is preferably cut in its whole core region, whereas its cladding region is only partially cut. More preferably, at least a portion of the cladding region comprised between the fiber core and the central element 70 is left uncut.

The operation of the probe 7 shown in the FIGS. 5a and 5b will be described herein after.

When the laser source emits a light radiation, such radiation is coupled to the first end of the probe 7, so that each optical fiber 72, 73, 75 and 76 of the optical guide structure guides a respective radiation component. Preferably, the radiation components guided by the fibers 72, 73, 75 and 76 have substantially identical optical powers. In this way, the intensity profile of the radiation guided within the guide structure also has a rotational symmetry about the axis z with a rotation angle of 180°.

Also in this case, it is assumed that, at least at the end 7″ of the probe 7, within the fibers 72, 73, 75 and 76 the radiation propagates only according to the respective fundamental modes, so that the greatest part of the optical power associated to each radiation component is concentrated in the respective cores.

When each radiation components reaches the point at which the respective fiber is obliquely cut, it undergoes reflection.

Subsequently, the reflected part of each radiation component propagates within the probe until, at the interface between the respective fiber and the fluid, it undergoes refractions, thus being emitted by the probe. In particular, the fibers 72, 73, 75 and 76 emit the respective components with an output angle relative to the direction z, which has a same value φ.

This means that the radiation components guided by the fibers 72, 73, 75 and 76 are made to converge at a point F, substantially placed on the axis z at a convergence distance df from the end 7″ of the probe 7.

If a further radiation (emitted always by the source 3 or by another source not shown) is coupled to the optical fibers 71 and 74, since the planes cutting the fibers 71 and 74 are deflected each relative to the plane defined by the axis of the probe 7 and the respective axis of the fiber 71 and 74, the components guided by the fibers 71 and 74 do not converge at the point F, since their trajectories are skew to the direction z, as shown by the bold arrows in FIG. 5a. Indeed, at the distance df the two components pass through points symmetric relative to the direction z, indicated as P1 and P2 in FIG. 5b.

Therefore, advantageously, a particle placed in suspension within a fluid may advantageously be trapped in the stable equilibrium point F and then rotated about the direction z thanks to the scattering force applied by the two radiation components emitted by the fibers 71 and 74.

According to a variant not shown in the drawings, all the optical fibers 71, 72, 73, 74, 75 and 76 are cut according to planes forming a same tapering angle with the plane defined by the directions x and y and a same deflection angle with the plane defined by the longitudinal axis z of the probe 7 and the fiber axis. Accordingly, all the components emitted by the fibers do not converge exactly in the point F shown in FIG. 5b, since they all have skew trajectories relative to the direction z. Indeed, at the distance df the components pass through respective points corresponding to vertexes of a regular hexagon perpendicular to the direction z.

In this way, if the sizes of the regular hexagon are lower than or comparable to that of the particle to be manipulated, an optical trap with an intensity lower than that created by the probe 7 shown in FIGS. 5a and 5b is created, and additionally the particle is rotated about the direction z by the scattering force applied by all the components.

Further, according to variants not shown in the drawings, the fiber 74 may be not used or it may be used for other purposes (illuminating the particle, irradiating the particle, etc.). Therefore, only the component emitted by the fiber 71 applies a scattering force to the particle. This does not induce a rotation of the particle about the axis z, but it induces a rotation of the particle on a plane comprising its own axis.

Further, according to variants not shown in the drawings, the fibers forming the guide structure suitable for creating the equilibrium point may lie on a same circumference, and the fiber(s) suitable for applying the scattering force inducing the particle rotation may be arranged externally or internally to such a circumference.

FIGS. 6a and 6b show a probe 8 usable for implementing the device 1 of FIG. 1 according to a third embodiment of the present invention. In particular, the probe 8 shown in FIGS. 6a and 6b is suitable for shifting a particle placed in suspension within a fluid along a predetermined circumference.

The probe 8 of FIGS. 6a and 6b comprises six optical fibers 81, 82, 83, 84, 85, 86 and an elongated central element 80. The elongated central element 80 may be for instance a dielectric material reinforcing element, or an optical fiber. Preferably, the optical fibers 81, 82, 83, 84, 85, 86 have substantially identical optical and geometrical characteristics.

Further, preferably, at least at the second end 8″, the central element 80 and the fibers 81, 82, 83, 84, 85, 86 have the axis parallel to the first direction z. Further, preferably, at least at the second end 8″, the axes of the fibers 81, 82, 83, 84, 85, 86 are located at the vertexes of a regular hexagon lying on a plane perpendicular to the direction z, shown in dashed line in FIG. 6a.

As shown in FIG. 6b, the end 8″ of the probe 8 has a tapered shape along the direction z.

In particular, the fibers 81 and 82 are obliquely cut according to planes forming with the plane identified by the directions x and y respective tapering angles, and forming with the plane perpendicular to the hexagon side comprised between them respective deflection angles. Similarly, the fibers 83 and 84 are obliquely cut according to planes forming with the plane identified by the directions x and y respective tapering angles, and forming with the plane perpendicular to the hexagon side comprised between them respective deflection angles. Finally, the fibers 85 and 86 are obliquely cut according to planes forming with the plane identified by the directions x and y respective tapering angles, and forming with the plane perpendicular to the hexagon side comprised between them respective deflection angles. Preferably, the tapering angle of the fibers 81, 82, 83, 84, 85 and 86 have all a same value Θ, and also the deflection angles of the fibers 81, 82, 83, 84, 85 and 86 have all a same value. Three different optical guide structure are then provided, comprising the fibers 81 and 82, the fibers 83 and 84, and the fibers 85 and 86, respectively.

Even though for simplicity FIG. 6b shows that the fibers are cut across their whole section, each fiber is preferably cut in its whole core region, whereas its cladding region is only partially cut.

The operation of the probe 8 shown in FIGS. 6a and 6b will be now described in detail herein after.

When the laser source emits a light radiation, such radiation is coupled to the first end of the probe 8, so that each optical fiber 81, 82, 83, 84, 85 and 86 guides a respective radiation component. Preferably, the radiation components guided by the fibers 81, 82 have substantially the same optical power. Further, preferably, the radiation components guided by the fibers 83, 84 have substantially the same optical power. Further, preferably, the radiation components guided by the fibers 85, 86 have substantially the same optical power.

Also in this case, it is assumed that, at least at the end 8″ of the probe 8, in the fibers 81, 82, 83, 84, 85 and 86 the radiation propagates only according to respective fundamental modes, so that the greater part of the optical power associated to each radiation component is concentrated in the respective core.

When each radiation component reaches the point in which the respective fiber is obliquely cut, it undergoes reflection.

Then, the reflected part of each radiation component propagates within the probe until, at the interface between the respective fiber and the fluid, it undergoes refraction, thus being emitted by the probe. In particular, all the fibers 81, 82, 83, 84, 85 and 86 emit the respective component with an output angle φ, which is the same for all the fibers.

However, due to deflection of the planes according to which the fibers are cut, the components emitted by the fibers 82 and 83 converge in a first point F, the components emitted by the fibers 84 and 85 converge in a second point F′ and the components emitted by the fibers 81 and 86 converge in a third point F″. The projections of the points F, F′ and F″ are shown in FIG. 6a. Such points F, F′ and F″ lie on a circumference belonging to a plane perpendicular to the direction z. The three guide structures of the probe 8 then create three stable equilibrium points F1, F1′ and F1″, shown in FIG. 6b, which lie on a circumference t positioned on a plane perpendicular to the direction z and having a certain distance df1 from the end 8″ of the probe 8.

Accordingly, a particle suspended in a fluid may advantageously be translated along the circumference t by modifying the optical power of the components guided by the first guide structure (fibers 82 and 83) and/or the optical power of the components guided by the second guide structure (fibers 84 and 85) and/or the optical power of the components guided by the third guide structure (fibers 81 and 86). The particle movement is indicated in FIG. 6b by the arrow Rv.

For instance, at the beginning the optical power of the components guided by the first guide structure may be higher than the optical power of the components guided by the second and third guide structures, so that the particle is drawn towards the equilibrium point F1 and is trapped within it. Afterwards, the optical power of the components guided by the first guide structure may be reduced, while the optical power of the components guided by the second guide structure may be increased, so that the particle is drawn towards the second equilibrium point F1′. Finally, the optical power of the components guided by the second guide structure may be reduced, while the optical power of the components guided by the third guide structure may be increased, so that the particle is drawn towards the equilibrium point F1″. The particle speed may be advantageously controlled by controlling the variation rate of the optical powers of the components guided by the first, second and third guide structures.

The probe 8 shown in FIGS. 6a and 6b has three guide structures, each comprising two fibers. However, in general, the probe 8 may comprise any number of guide structures, each comprising a respective number of optical fibers for generating a respective equilibrium point. The fibers of different guide structures may be placed on a same circumference (as shown in FIG. 6a), or on concentric circumferences.

Preferably, in the various embodiments of the probe which are shown in the drawings and have been described above, the optical fibers comprised in the probe are single mode fibers at the radiation wavelength. Preferably, the numerical aperture of such optical fibers is comprised between 0.05 and 0.16, more preferably between 0.08 and 0.14, even more preferably between 0.10 and 0.12. These values of numerical aperture advantageously allow to keep the converge point of the radiation at a non-zero distance (10 μm to 200 μm) from the second end of the probe, thus allowing easier manipulation of the particles.

Moreover, preferably, the external diameter of each optical fiber is preferably lower than or equal to 125 microns, more preferably lower than or equal to 80 microns. Further, preferably, the ratio between the diameter of the fiber core and the diameter of the fiber radius is preferably comprised between 0.04 and 0.4, more preferably between 0.08 and 0.2. This advantageously allows to increase the size of the uncut cladding portions wherein the points at which each radiation component exits the probe (see for instance points B1 and B2 shown in FIG. 3) are preferably positioned. This advantageously provides higher tolerances for the choice of the tapering angle.

The above described device may have different applications. For instance, it may be advantageously used for performing an analysis of particles according to different techniques such as for instance: Raman spectroscopy, CARS (“Coherent Anti-stokes Raman Spectroscopy”), fluorescence analysis, two-photons analysis, OCT (“Optical Coherence Tomography”) and FTIR (“Fourier Transform InfraRed spectroscopy”). According to the technique to be executed, the disclosed probe may comprise other optical, mechanical, electrical or magnetic elements, such as for instance:

one or more rod-shaped conductors for measuring the electric potential or for inducing a certain electrical potential in the equilibrium point created by the probe;

an electrical resistance for increasing the particle temperature by means of the Joule effect;

a magnetic element or a superconductor for applying a magnetic field to the trapped particle;

a capillary for removing some material from the point in which the particle is trapped or for introducing material (e.g. for analysing the chemical reaction of the particle when brought into contact with a given substance);

an optical fiber for irradiating the particle or for collecting the radiation scattered by the particle.

1. An optical device (1) for manipulating a particle immersed in a fluid, comprising a light source (3) and a probe (2, 6, 7, 8) having a first end (2′), a second end (2″, 6″, 7″, 8″) and a longitudinal axis (z), the probe (2, 6, 7, 8) being suitable for receiving a radiation from the light source (3) at the first end (2′) and for outputting the radiation through the second end (2″, 6″, 7″, 8″), wherein the probe comprises:
an optical guide structure suitable for receiving the radiation, the optical guide structure being configured so that:
at the second end (2″, 6″, 7″, 8″), the radiation has an optical intensity distribution with an intensity maximum placed at a non-zero distance from the longitudinal axis (z) of the probe; and
in a region of the intensity maximum, the radiation is reflected at an interface between the second end (2″, 6″, 7″, 8″) and the fluid and is emitted by the second end (2″, 6″, 7″, 8″) so that it converges in a convergence point (F), thus creating an equilibrium point (F1); and
optical means suitable for perturbing said equilibrium point (F1).

2. The device (1) according to claim 1, wherein, at least in the region of said intensity maximum, said probe (2, 6, 7, 8) has a tapered shape having a rotational symmetry about the longitudinal axis (z) and having a given tapering angle (Θ).

3. The device (1) according to claim 2, wherein said second end (2″, 6″, 7″, 8″) is configured such that it has a non-tapered region which does not overlap with said region of said intensity maximum, said radiation being emitted at least at one point (B1, B2) which is positioned in said non-tapered region.

4. The device (1) according to claim 2, wherein the optical guide structure comprises at least two optical fibers (11, 12; 61, 63, 65; 72, 73, 75, 76), configured so that they have the same optical and geometrical characteristics, said at least two optical fibers (11, 12; 61, 63, 65; 72, 73, 75, 76), at said second end (2″, 6″, 7″) of the probe (2, 6, 7) being arranged parallel to the longitudinal axis (z) with a substantially rotational symmetry about said longitudinal axis (z).

5. The device (1) according to claim 4, wherein each of said at least two optical fibers (11, 12; 61, 63, 65; 72, 73, 75, 76), at said second end (2″, 6″, 7″) of the probe (2, 6, 7) is cut at least in the region of its core according to a plane (p1, p2) forming an angle (Θ1, Θ2) with a plane perpendicular to the longitudinal axis (z), said angle (Θ1, Θ2) being equal to said tapering angle (Θ).

6. The device (1) according to claim 4, wherein said perturbation optical means comprise an optical fiber (10) having an axis substantially coincident with said longitudinal axis (z) of the probe, said optical fiber (10) being suitable for emitting a further radiation directed along said longitudinal axis (z), thus shifting said equilibrium point (F1) along said longitudinal axis (z).

7. The device (1) according to claim 4, wherein said perturbation optical means comprise a further optical guide structure suitable for receiving a further radiation, said further optical guide structure being configured so that:
at the second end (6″), the further radiation has an optical intensity distribution with an intensity maximum placed at a non-zero distance from the longitudinal axis (z) of the probe; and
in the region of the intensity maximum, the further radiation is reflected at the interface between the second end (6″) and the fluid, and it is emitted by the second end (6″) so that it converges in a further convergence point (F′), thus creating a further equilibrium point (F1′).

8. The device (1) according to claim 7, wherein the further optical guide structure comprises at least two further optical fibers (62, 64, 66), configured to have the same optical and geometrical characteristics, said at least two further optical fibers (62, 64, 66), at the second end (6″) of the probe (6), being arranged parallel to the longitudinal axis (z) with a substantially rotational symmetry about said longitudinal axis (z).

9. The device (1) according to claim 7, wherein the perturbation optical means further comprise means for varying the ratio between the optical power of said radiation and the optical power of said further radiation, thus shifting said particle between said equilibrium point (F1) and said further equilibrium point (F1′).

10. The device (1) according to claim 7, wherein said further optical guide structure is arranged concentrically to said optical guide structure.

11. The device according to claim 4, wherein said perturbation optical means comprise an optical fiber (71, 74) placed at a non-zero distance from said longitudinal axis (z), said optical fiber (71, 74) being configured to emit a further radiation having a skew trajectory relative to said longitudinal axis (z), thus impressing a rotation to said particle.

12. The device according to claim 4, wherein said perturbation optical means comprise means for varying a wavelength of said radiation, thus shifting said equilibrium point (F1) along said longitudinal axis (z).

13. The device (1) according to claim 4, wherein said perturbation optical means comprise means for varying an optical power of said radiation, thus applying a compression to said particle.

14. The device according to claim 2, wherein said perturbation optical means are suitable for creating at least a further equilibrium point (F1′, F1″), said equilibrium point (F1) and said further equilibrium point (F1′, F1″) lying on a same plane perpendicular to said longitudinal axis (z).

15. The device (1) according to claim 14, wherein said guide structure comprises a first number of fibers (81, 82) and said perturbation optical means comprise a second number of fibers (83, 84, 85, 86), said first number of fibers and said second number of fibers being arranged according to a rotational symmetry about said longitudinal axis (z).

16. A probe (2, 6, 7, 8) having a first end (2′), a second end (2″, 6″, 7″, 8″) and a longitudinal axis (z), the probe (2, 6, 7, 8) being suitable for receiving a radiation from a light source (3) at the first end (2′) and for emitting the radiation through the second end (2″, 6″, 7″, 8″), wherein the probe (2, 6, 7, 8) comprises:
an optical guide structure suitable for receiving the radiation, the optical guide structure being configured so that:
at the second end (2″, 6″, 7″, 8″), the radiation has an optical intensity distribution with an intensity maximum placed at a non-zero distance from the longitudinal axis (z) of the probe; and
in a region of the intensity maximum, the radiation is reflected at an interface between the second end (2″, 6″, 7″, 8″) and the fluid and is emitted by the second end (2″, 6″, 7″, 8″) such as to converge in a convergence point (F), thus creating an equilibrium point (F1); and
perturbation optical means suitable for perturbing said equilibrium point (F1).

17. Method for manipulating a particle immersed in a fluid, comprising the steps of:
generating a radiation by means of a laser source (3);
guiding the radiation from a first end (2′) to a second end (2″, 6″, 7″, 8″) of a probe (2, 6, 7, 8) by means of an optical guide structure so that, at the second end (2″, 6″, 7″, 8″) of the probe (2, 6, 7, 8), the radiation has an optical intensity distribution with an intensity maximum placed at a non-zero distance from a longitudinal axis (z) of the probe (2, 6, 7, 8);
at second end (2″, 6″, 7″, 8″) and in the a region of the intensity maximum, reflecting the radiation at an interface between the second end (2″, 6″, 7″, 8″) and the fluid;
emitting the radiation from the second end (2″, 6″, 7″, 8″) so that it converges in a convergence point (F), thus creating an equilibrium point; and
perturbing said equilibrium point (F1).

18. The method according to claim 17, wherein said step of perturbing comprises a step of emitting, by means of an optical fiber (10) having an axis substantially coincident with said longitudinal axis (z) of the probe, a further radiation directed along said longitudinal axis (z) thus translating said equilibrium point (F1) along said longitudinal axis (z).

19. The method according to claim 17, wherein said step of perturbing comprises the following steps:
generating a further radiation;
guiding the further radiation from the first end (2′) to the second end (2″, 6″, 7″, 8″) of the probe (2, 6, 7, 8) by means of a further optical guide structure so that, at the second end (2″, 6″, 7″, 8″) of the probe (2), the further radiation has an optical intensity distribution with an intensity maximum placed at a non-zero distance from the longitudinal axis (z) of the probe;
at the second end (2″, 6″, 7″, 8″) and in the region of the intensity maximum, reflecting the further radiation at the interface between the second end (2″, 6″, 7″, 8″) and the fluid; and
emitting the further radiation from the second end (2″, 6″, 7″, 8″) so that it converges in a further convergence point (F), thus creating a further equilibrium point (F).

20. The method according to claim 19, wherein said step of perturbing further comprises, after the step of emitting the further radiation, a step of varying the ratio between the optical power of said radiation and the optical power of said further radiation, thus shifting said particle between said equilibrium point (F1) and said further equilibrium point (F1′).

21. The method according to claim 17, wherein said step of perturbing comprises a step of emitting, by means of an optical fiber (71, 74) placed at a non-zero distance from said longitudinal axis (z), a further radiation having a skew trajectory relative to said longitudinal axis (z), thus impressing a rotation on said particle.

22. The method according to claim 17, wherein said step of perturbing comprises a step of varying a wavelength of said radiation, thus shifting said equilibrium point (F1) along said longitudinal axis (z).

23. The method according to claim 17, wherein said step of perturbing comprises a step of varying an optical power of said radiation, thus applying a compression on said particle.

24. The method according to claim 17, wherein said step of perturbing comprises a step of creating at least a further equilibrium point (F1′, F1″), said equilibrium point (F1) and said further equilibrium point (F1′, F1″) lying on a same plane perpendicular to said longitudinal axis (z).
